(19) United States
(12) Patent Application Publication
(10) Pub. No.: US 2013/0198657 A1
(43) Pub. Date: Aug. 1, 2013

(54) Integrated Public/Private Online Conference

(71) Applicant: American Teleconferencing Services, Ltd., Atlanta, GA (US)

(72) Inventors: Boland T. Jones, Atlanta, GA (US); David Michael Guthrie, Norcross, GA (US); Mark A. Sjurseth, Smyrna, GA (US); John P. Keane, Marietta, GA (US)

(73) Assignee: AMERICAN TELECONFERENCING SERVICES, LTD., Atlanta, GA (US)

(21) Appl. No.: 13/802,037

(22) Filed: Mar. 13, 2013

Related U.S. Application Data
(63) Continuation-in-part of application No. 12/789,993, filed on May 28, 2010.
Application No. 12/789,993 is a continuation-in-part of application No. 12/772,069, filed on Apr. 30, 2010.

(51) Int. Cl. H04L 29/06

(52) U.S. Cl. CPC H04L 65/403
USPC 715/758; 715/753

(57) ABSTRACT

Various embodiments of systems, methods, and computer programs are disclosed for providing an integrated public/private online conference. One embodiment is computer program embodied in a computer readable medium and executable by a processor for providing an online conference. One such computer program comprises: logic configured to establish an audio conference between a plurality of participants operating corresponding computing devices connected via a communication network; logic configured to designate at least one of the participants as a private participant that participates in the audio conference in a private mode and a remaining portion of the participants that participant in the audio conference in a public mode; and logic configured to present the audio conference to the public participants via a public conference interface that visually identifies only the public participants.

### CROSS-REFERENCE TO RELATED APPLICATIONS

This application is a continuation-in-part patent application of and claims the benefit of the priority of the following patents applications, each of which is hereby incorporated by reference in its entirety: U.S. patent application Ser. No. 12/789,993, entitled “Systems, Methods, and Computer Programs for Providing a Conference User Interface” and filed May 28, 2010 (Attorney Docket No. 16003.1206U1); and U.S. patent application Ser. No. 12/772,069, entitled “Managing Conference Sessions via a Conference User Interface” and filed Apr. 30, 2010 (Attorney Docket No. 16003.1210U1).

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other multimedia, text, graphics, etc. These types of convenient conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of systems, methods, and computer programs are disclosed for providing an integrated public/private online conference. One embodiment is a method for providing an online conference. One such method comprises: a conferencing system establishing an audio conference between a plurality of participants accessing the conferencing system via a communication network; the conferencing system electronically designating at least one of the participants as a private participant and a remaining portion as public participants; and the conferencing system presenting to the public participants the audio conference and a public conference interface, the public conference interface displaying a participant object identifying each of the public participants without identifying the private participant to the public participants.

Another embodiment is computer program embodied in a computer readable medium and executable by a processor for providing an online conference. One such computer program comprises: logic configured to establish an audio conference between a plurality of participants operating corresponding computing devices connected via a communication network; logic configured to designate at least one of the participants as a private participant that participates in the audio conference in a private mode and a remaining portion of the participants that participant in the audio conference in a public mode; and logic configured to present the audio conference to the public participants via a public conference interface that visually identifies only the public participants.

A further embodiment is a computer system comprising a conferencing system and a server. The conferencing system establishes an audio conference between a plurality of participants operating computing devices connected via a communication network. The server is configured to communicate with the conferencing system and the plurality of computing devices via the communication network. The server comprises one or more processors and a private participant control module, which is stored in a computer readable medium and executed by the processors. The private participant control module comprises: logic configured to designate at least one of the participants as a private participant that participates in the audio conference in a private mode and a remaining portion of the participants that participant in the audio conference in a public mode; logic configured to present the audio conference to the public participants via a public conference interface that visually identifies only the public participants; and logic configured to present the audio conference to the private participants via a private conference interface that visually identifies the public participants and the private participants.

### BRIEF DESCRIPTION OF THE DRAWINGS

FIG. 1 is a block diagram illustrating an embodiment of a computer system for providing an integrated public/private online conference.

FIG. 2 is a combined block/flow diagram illustrating an embodiment of the private participant control module of FIG. 1 for providing, managing, and controlling the integrated public/private online conference.

FIG. 3 is a flowchart illustrating the architecture, operation, and/or functionality of an embodiment of the private participant control module of FIGS. 1 & 2.

FIG. 4 is a user interface screen shot illustrating an embodiment of the public conference interface presented to public participants.

FIG. 5 illustrates an implementation of an interactive participant object in the public conference interface of FIG. 4.

FIG. 6 is a user interface screen shot illustrating an embodiment of the private conference interface presented to private participants.

FIG. 7 illustrates the public conference interface of FIG. 4 after a private participant has changed from the private mode to the public mode and has been added to the public conference interface.

FIG. 8 illustrates the private conference interface of FIG. 6 in which private participants are privately interacting via a private chat application.

### DETAILED DESCRIPTION

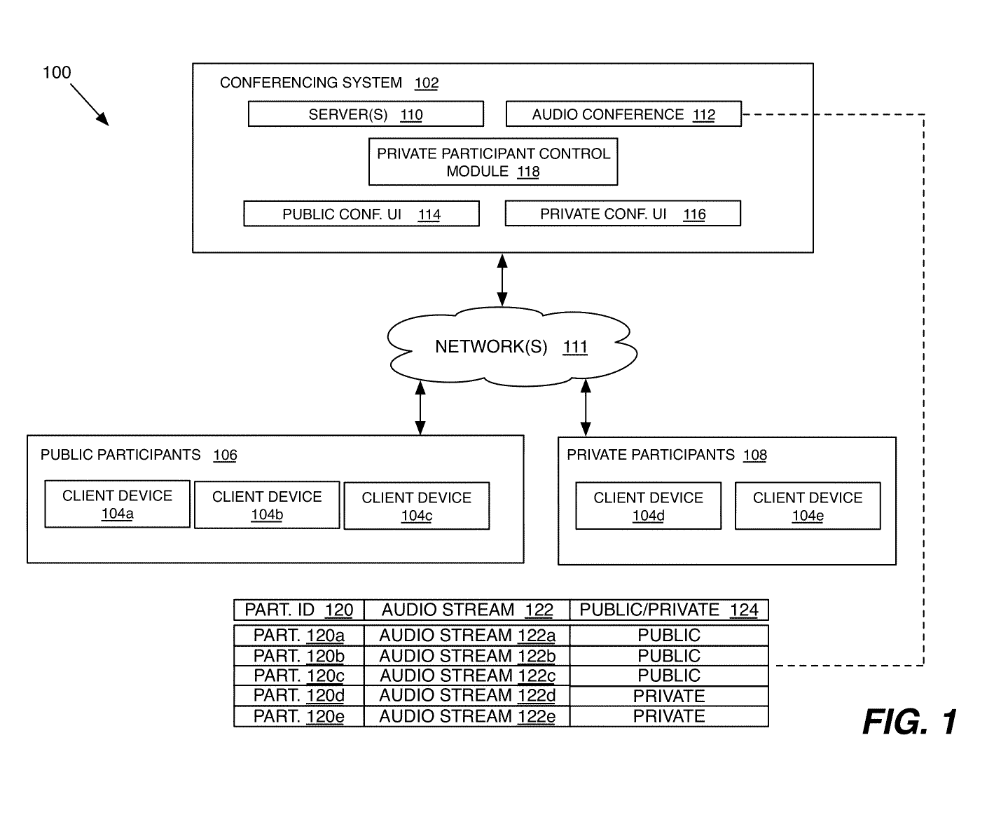

Various embodiments of systems, methods, and computer programs are disclosed for providing an online conference having public and private participants (referred to as an “integrated public/private online conference”). Various embodiments of the integrated public/private online conference are described below in more detail with reference to FIGS. 1-8. As an introductory matter, however, an exemplary embodiment of an integrated public/private online conference will be generally described. The integrated public/private online conference comprises an online conference that may provide a visually engaging conference experience to participants of a conference via a conference user interface presented to a client device. The online conference enables the participants to selectively control whether they will participate in a public mode as a public participant or in a private mode as a private participant. In general, public participants participate in the online conference in a conventional manner. Public participants are identified in the online conference (e.g., by displaying a name, a photograph, an avatar, or other information identifying the participant) so that other participants know they are participating in the online conference. Private participants, however, are able to experience the online conference without being identified to the public participants.

A conferencing system implements the integrated public/private online conference by providing and managing two separate versions of the conference user interface: (1) a public conference user interface presented to public participants; and (2) a private conference user interface presented to private participants. In the public conference user interface, only the identities of the public participants are presented. The identities of the private participants are not presented to the public participants. The private participants experience the online conference via the private conference user interface, which presents the identities of the public participants and may selectively identify one or more of the private participants. Private participants are able to experience the interactions of the public participants, such as, for example, by listening to a corresponding audio conference or viewing any messages, documents, media, or other content shared between the public participants via the public conference user interface. Furthermore, the private conference user interface may be configured to enable two or more private participants to interact with each other. Private participants may exchange messages, share documents, collaborate via a virtual whiteboard or other collaboration application, or otherwise privately interact with each other.

The integrated public/private online conference may be used for conferences, meetings, groupings or other types gatherings (collectively, a “conference” with a system that provides the public and private conference user interfaces for the conference being referred to herein as a “conferencing system”) for any variety of purposes of one or more people, groups or organizations (including combinations thereof and collectively referred to as “participants”) with or without an audio component, including, without limitation, enabling simulcast audio with such conference for the participants. The public and/or private conference user interfaces may be configured to provide any desirable content and/or functionality and may support various user interface and/or conferencing features, including any features described in the above-referenced related patent applications.

FIG. 1 illustrates an embodiment of a computer system 100 for providing an integrated public/private online conference. The computer system 100 enables participants selectively control whether they will participate in a public mode as a public participant 106 or in a private mode as a private participant 108. The computer system 100 comprises a conferencing system 102 and a plurality of client devices 104 connected via one or more communication networks 111. The network(s) 111 may support wired and/or wireless communication via any suitable protocols, including, for example, the Internet, the Public Switched Telephone Network (PSTN), cellular or mobile network(s), local area network(s), wide area network(s), or any other suitable communication infrastructure. The client devices 104 may be associated with corresponding participants of the online conference, such as, an audio conference 112. A participant may comprise a “host” or “participant” and such terms merely refer to different user roles or permissions associated with the audio conference 112. For example, the “host” may be the originator of the audio conference 112 and, consequently, may have user privileges that are not offered to the participants. Nonetheless, it should be appreciated that the terms “host,” “participant,” and “user” may be used interchangeably depending on the context in which it is being used.

The client devices 104 may comprise any desirable computing device, which is configured to communicate with the conferencing system 102 and the server(s) 110 via the networks 111. The client device 104 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device capable of communicating with the conferencing system 102 and/or the server(s) 110 via one or more networks 111. The client device 104 may include client software (e.g., a browser, plug-in, or other functionality) configured to facilitate communication with the conferencing system 102 and the server 110. It should be appreciated that the hardware, software, and any other performance specifications of the client device 104 are not critical and may be configured according to the particular context in which the client device 104 is to be used.

In the embodiment of FIG. 1, the conferencing system 102 generally comprises a communication system for establishing an online conference (e.g., an audio conference 112) between the client devices 104. The conferencing system 102 may support audio via a voice network and/or a data network. In one of a number of possible embodiments, the conferencing system 102 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 102 may support various alternative platforms, technologies, protocols, standards, features, etc. Regardless of the communication infrastructure, the conferencing system 102 may be configured to establish an audio connection with the client devices 104, although in some embodiments the audio portion may be removed. The conferencing system 102 may establish the audio conference 112 by combining audio streams 122a-122e associated with client devices 102a-102e and corresponding public participants 106 and private participants 108. In the embodiment illustrated in FIG. 1, the audio conference 112 comprises a group of public participants 106 (client devices 104a, 104b, and 104c) and two private participants 108 (client devices 104d and 104e).

In general, the conferencing system 102 establishes the audio conference 112 between the participants. The participants may selectively control whether to enter the audio conference 112 in either the public mode or the private mode. Based on a participant or host selection when entering the audio conference 112 (or automatically defined according to user profiles or the manner in which the online conference is configured by a host or other participant), the conferencing system 102 designates the participants as either a public participant 106 or a private participant 108.

As illustrated in FIG. 1, the conferencing system 102 may maintain a database 121 stored in a memory. Database 121 may comprise a list of participant identifiers 120 identifying each of the participants. Each participant identifier 120 is logically associated with a corresponding audio stream 122 that identifies the participant, a particular connection to the appropriate client device 104, and a public/private configuration parameter 124 for designating a participant as a public participant 106 or a private participant 108. For example, users associated with client devices 104a, 104b, and 104c may be designated by the conferencing system 102 as public participants 106 with corresponding participants identifiers 120a, 120b, and 120c and audio streams 122a, 122b, and 122c, respectively. Each of the public participants 106 may be identified as “public” via the public/private configuration parameter 124. Users associated with client devices 104d and 104e may be designated by the conferencing system 102 as private participants 108 with corresponding participant identifiers 120d and 120e and audio streams 122d and 122e, respectively. Each of the private participants 108 may be identified as “private” via the public/private configuration parameter 124.

It should be appreciated that the public/private configuration parameter 124 may be manually defined by the participants or a host before, after, or during the audio conference 112. In other embodiments, the conferencing system 102 may automatically configure the public/private configuration parameter 124 according to user profile parameters or based on conference parameters. For example, a host may specify the private participants 108 when scheduling the online conference. The participants may also be prompted to specify whether to join the online conference in the public or private mode. Participants may also selectively change the public/private configuration parameter 124 during the online conference.

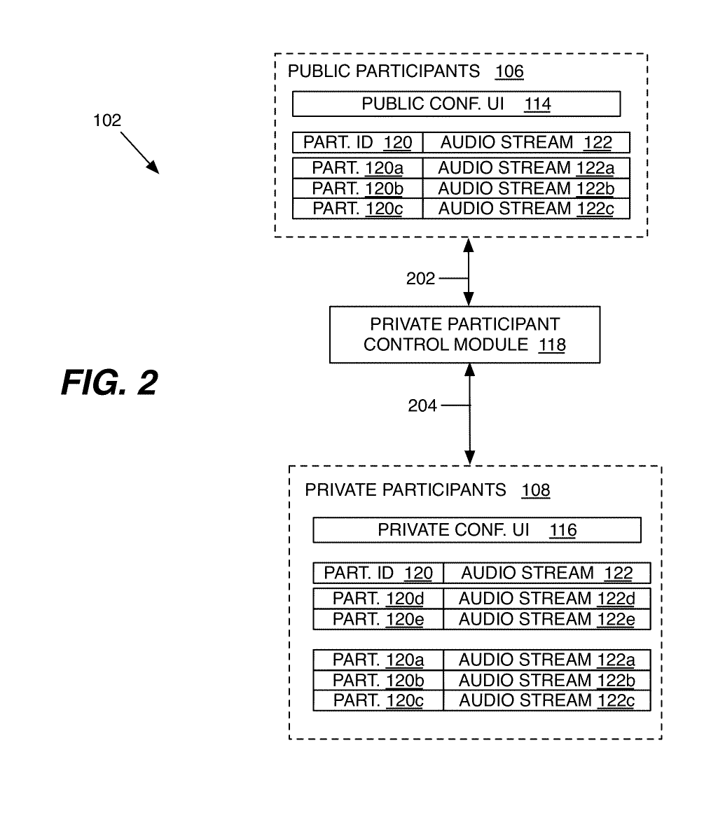

Conferencing system 102 may comprise one or more server(s) 110 that are configured to establish the audio conference 112, and a private participant control module 118 configured to present either a public conference user interface 114 or a private conference user interface 116 based on the public/private configuration parameter 124. As illustrated in FIG. 2, the conferencing system 102 presents public conference user interface 114 to public participants 106 and private conference user interface to private participants 108. The conferencing system 102 may access the database 121 (FIG. 1), read the public/private configuration parameter 124 for each participant, and determine the applicable conference user interface to be presented to the client devices 104. The conference user interfaces may be presented via a client application (e.g., a browser, one or more browser plug-ins, and/or a special-purpose client). It should be appreciated that the conference user interfaces may include logic located and/or executed at the client device 104, the conferencing system 106, or any combination thereof, and may be presented to and displayed via a graphical user interface and an associated display (e.g., touchscreen display device or other display device).

The private participant control module 118 (and any other associated control and presentation modules) may be embodied in memory and executed by one or more processors. It should be appreciated that any aspects of the private participant control module 118 may be stored and/or executed by the client devices 104, the conferencing system 102, the servers 110, or other related server(s) or web services. Referring to FIG. 2, the private participant control module 118 enables the conferencing system 102 to separately configure, manage, and control the presentation of the public conference user interface 114 to public participants 106 and the private conference user interface 116 to private participants 108. A communication channel 202 may be used for communications with public participants 106, including control of the active audio streams (audio streams 120a, 120b, and 120c), as well as presentation of content and/or functionality associated with the public conference user interface 114. The audio streams from the private participants 108 (e.g., audio streams 120d and 120e) may be muted or otherwise disabled so that they are not presented to the public participants 106.

Communications with the private participants 108 may be controlled via a communication channel 204. The private conference user interface 116 (and any content and/or functionality) may be provided via communication channel 204. All of the audio streams 122 in the audio conference 112 may be presented to the private participants 108. In an embodiment, the audio streams associated with the private participants 108 (audio streams 120d and 120e) may be configured to support two-way communication between the private participants 108 but disabling presentation to the public participants.

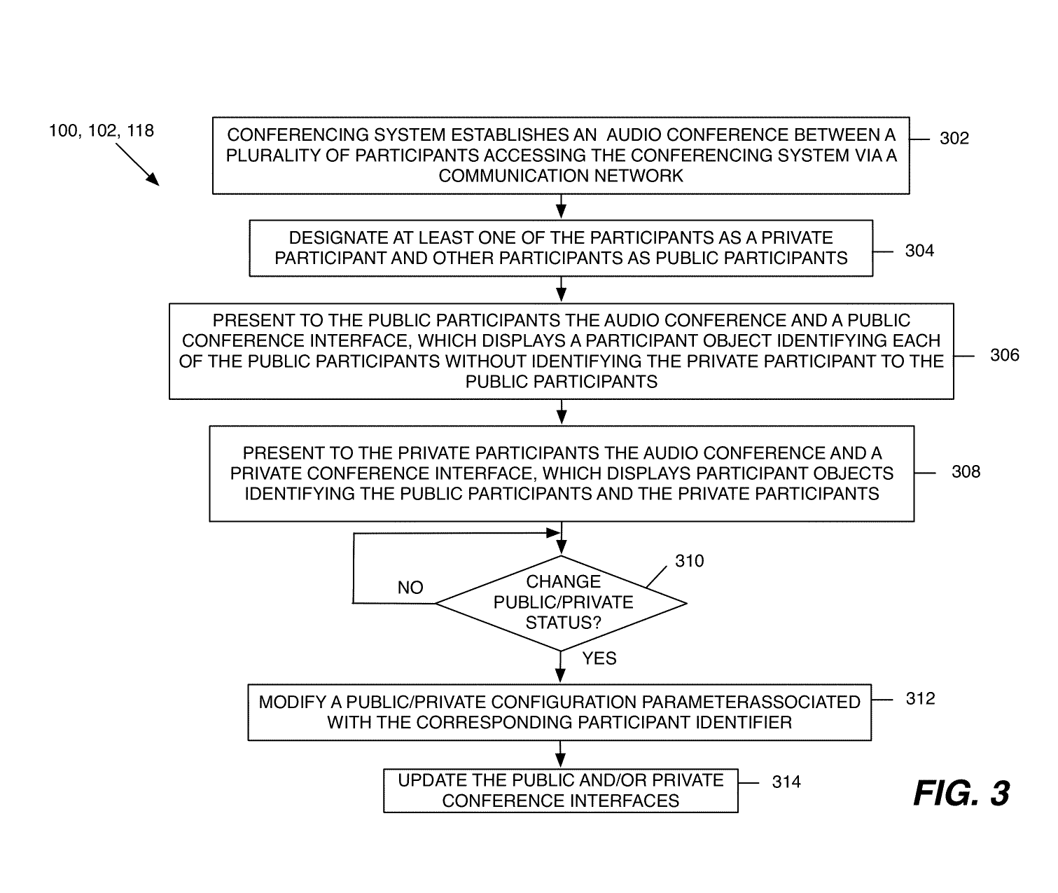

FIG. 3 is a flowchart illustrating the architecture, operation, and/or functionality of an embodiment of the computer system 100 of FIG. 1 for implementing an integrated public/private online conference. At block 302, the conferencing system 102 establishes an audio conference 112 between a plurality of participants accessing the conferencing system 102 via client device 104 connected to network(s) 111. At block 304, the conferencing system 102 designates at least one of the participants as a private participant 108 and the remaining participants as public participants 106. The public/private configuration parameters 124 may be stored in the database 121 and used to further control aspects of the integrated public/private online conference. At block 306, the conferencing system 102 presents the audio conference 112 and the public conference user interface 114 to the participants designated as public participants 106. The public conference user interface 114 may be configured to identify only the public participants 106 without identifying the private participants 108. It should be appreciated that the identification of the public participants 106 may be implemented in any desirable manner. In an embodiment, the public participants 106 may be identified in a simple participant list according to name, telephone number, or other information. In other embodiments, the public participants 106 may be identified with a photograph, a customized profile picture, or an avatar.

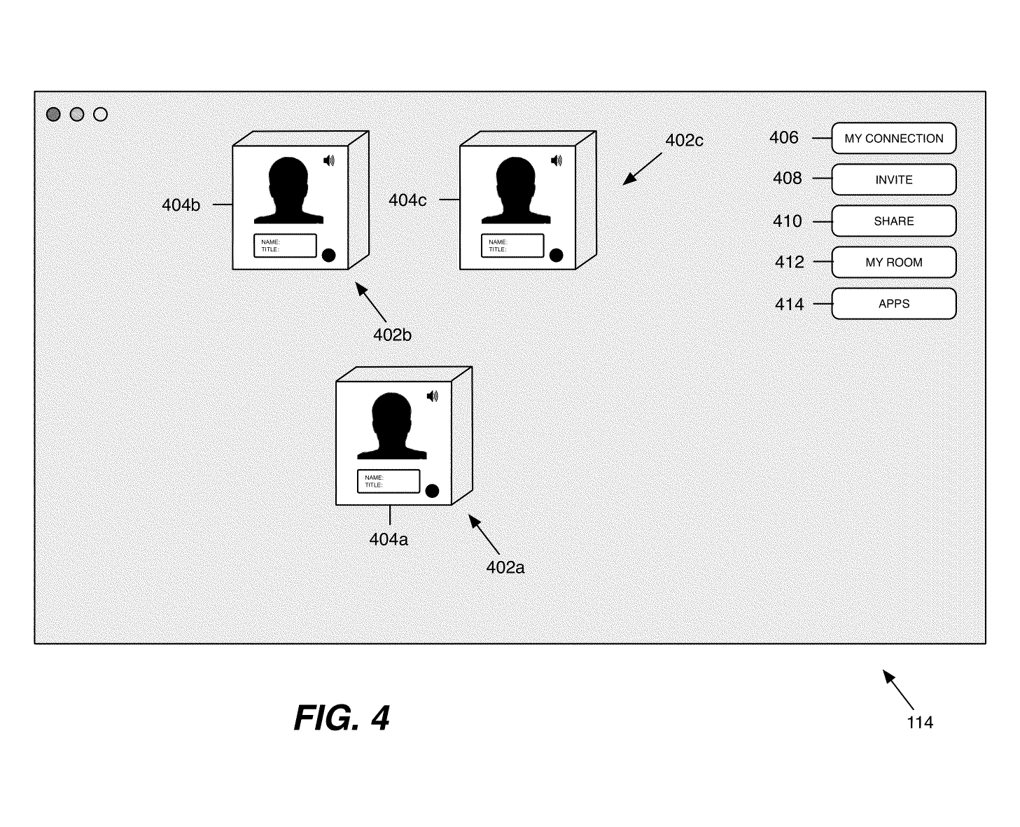

FIG. 4 illustrates an exemplary embodiment of the public conference user interface 114 in which each public participant 106 is identified with an interactive participant object 402. The interactive participant object 402 may display similar information as described in the above-referenced international patent applications (e.g., a graphical representation, profile information, an audio indicator, a business card component, etc.) and may implement similar or other user interface or other functions and features. In an embodiment, a business card component may “flip” the participant object 402 to display additional parameters. The interactive participant objects 402 may comprise further interactive functionality and visual effects. For example, the participant object 402 may comprise a cube having multiple display faces. When a participant selects a user interface component, the cube may be expanded to display one or more faces of the object.

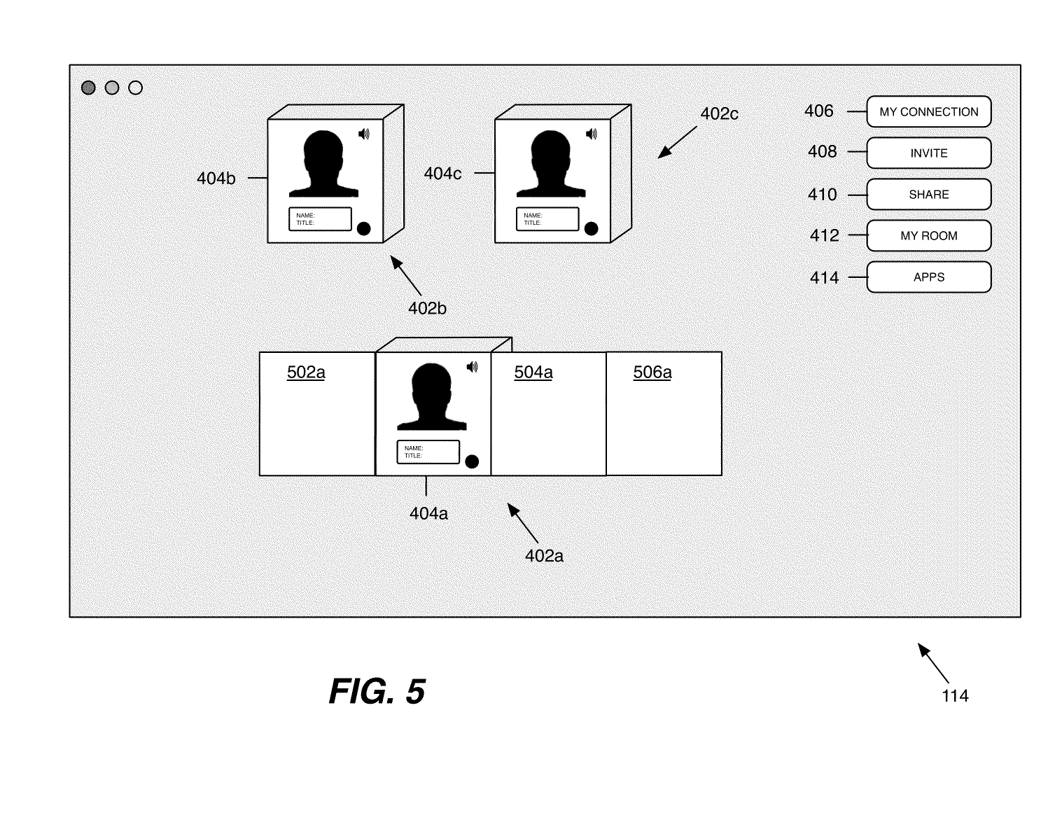

FIG. 5 illustrates the public conference user interface 114 in which a participant object 402a has been selected by one of the participants. The user selection may trigger the display of cube faces 502a, 504a, and 506a. Each face may display additional information about the associated participant. In an embodiment, the cube faces may be configurable by the participant and may display, for example, a social networking profile, updates to a social networking communication channel, video, graphics, images, or any other content. The cube faces may be further selected to return to the original collapsed cube. In another embodiment, the participant object 402 may be rotated (either automatically or via user selection) to display the respective cube faces 502a, 504a, and 506a. It should be appreciated that the participant objects 402 may be configured with additional or alternative visual effects and/or interactive functionality.

The public conference user interface 114 may comprise one or more selectable components for accessing various conferencing features. A my connection component 406 may launch a display for enabling a participant to configure the existing connection between the client device 104 and the conferencing system 102. The participant may disconnect a connection to the audio conference 112, establish a new connection to the audio conference 112 (e.g., by dial-out), or reconfigure the existing connection to the audio conference 112. In addition to configuring the audio connection, the participant may also configure the connection to the online conference via the public conference user interace 114. For example, a public participant 106 may selectively change to the private mode to give the impression to the other public participants 106 of having disconnected from the online conference.

An invite component 408 may launch a menu for enabling a participant to invite additional participants to the online conference. Additional participants may be invited by, for example, dialing out to a telephone number, sending an email including information for accessing the conferencing system 106, or sending a message to a web service, such as, for example, a social networking system.

A share component 410 may launch a menu (not shown) for enabling a participant to insert and share media with other participants in the online conference, as described in the above-referenced related patent applications.

A my room component 412 may launch a display for enabling a participant to configure the appearance of the conference user interface. The participant may configure the arrangement of the participant objects 402, specify a location view (as described in the above-reference international patent application), or configure any other presentation parameter.

An apps component 414 may launch a menu for enabling a participant to launch, view, or purchase various conference applications provided by the conferencing system 102.

Referring again to FIG. 3, at block 308, the conferencing system 102 presents the audio conference 112 and the private conference user interface 116 to the participants designated as private participants 108. The private conference user interface 116 may be configured to identify both the public participants 106 and the private participants 108. Otherwise, the private conference user interface 116 may be configured in a similar manner as the public conference user interface 114.

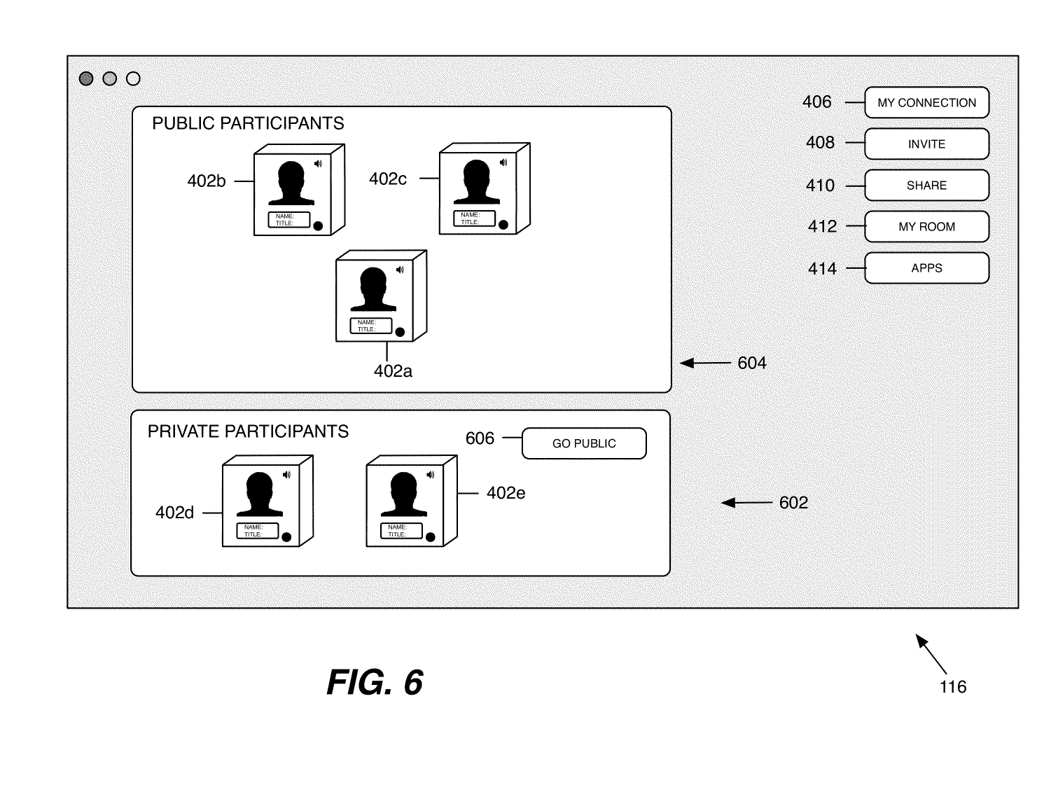

FIG. 6 illustrates an exemplary embodiment of a private conference user interface 116. Interactive participant objects 402a, 402b, and 402c associated with the public participants 106a, 106b, and 106c, respectively, may be presented in a screen portion or window 604 with an indication that these participants are participating in the public mode. Interactive participant objects 402d and 402e associated with the private participants 108d and 108e, respectively, may be presented in another screen portion or window 602 with an indication that these participants are participating in the private mode. Window 602 may include a “go public” button 606 for conveniently enabling private participants 108 to switch to the public mode.

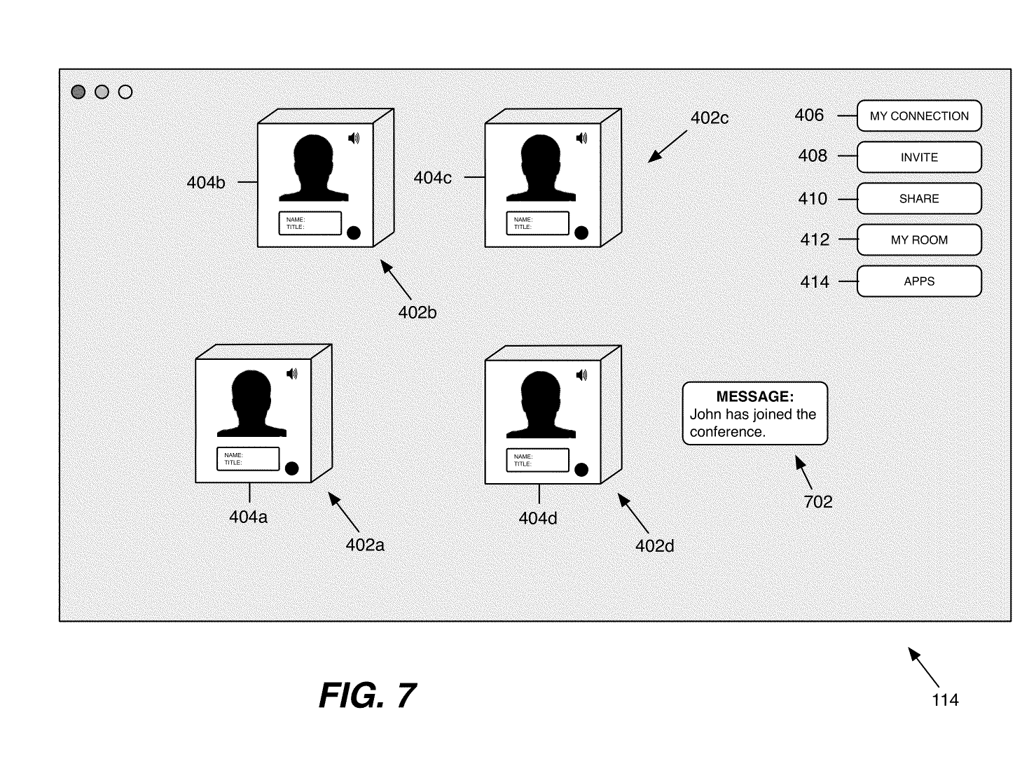

When a private participant 108 switches to the public mode, the corresponding interactive participant object 402 may be removed from the window 602 (FIG. 6) in the private conference user interface 116 and added to the public conference user interface 114 (FIG. 7) with a notification or alert message 702 indicating that a new participant has joined the online conference.

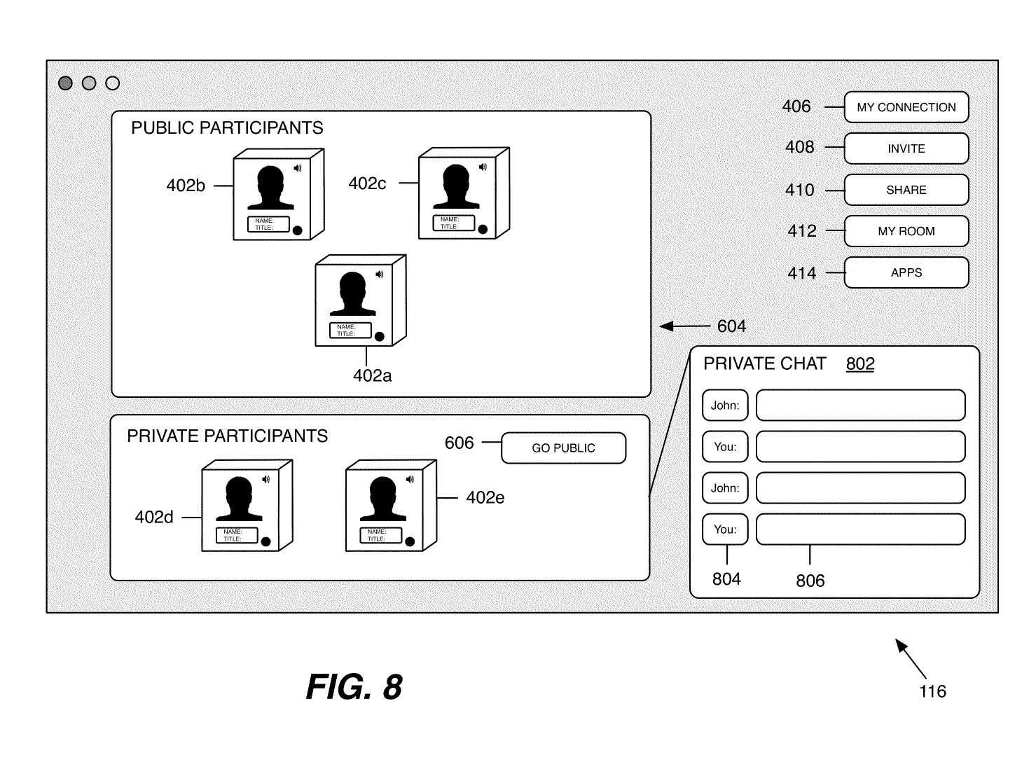

As described above, the private mode may be configured to enable private participants 108 to privately interact with each other without notifying any of the public participants 106. As illustrated in the embodiment of FIG. 8, the private conference user interface 116 may comprise a private chat window 802 that enables private participants 108 to initiate a chat with one or more other private participants 108. The private chat window 802 may display a participant indicator 804 and a text box 806 containing the contents of the messages. It should be appreciated that the private conference user interface 116 may support various alternative mechanisms for enabling private interaction, including, for example, by sending social networking messages, email messages, short messaging service (SMS) message, sharing documents, or collaborating with a virtual whiteboard application.

Referring again to FIG. 3, at decision block 310, the conferencing system 102 may monitor the private/public configuration parameters 124 (FIG. 1) to determine whether any of the participants have changed between the private and public modes. If a participant chooses to change modes, at block 312, the conferencing system 102 may modify the private/public configuration parameter 124 associated with the corresponding participant identifier 120. At block 314, the conferencing system 102 may update the conference user interfaces. For example, when a participant changes from public to private mode, the participant may be removed from the public conference user interface 114 and added to the private conference user interface 116.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the computer system 100. Furthermore, the logical functions may be embodied in any computer readable medium for use by or in connection with an instruction execution system, apparatus, or device, such as a computer-based system, processor-containing system, or other system associated with the computer system 100 that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A method for providing an online conference, the method comprising:
a conferencing system establishing an audio conference between a plurality of participants accessing the conferencing system via a communication network;
the conferencing system electronically designating at least one of the participants as a private participant and a remaining portion as public participants; and
the conferencing system presenting to the public participants the audio conference and a public conference interface, the public conference interface displaying a participant object identifying each of the public participants without identifying the private participant to the public participants.

2. The method of claim 1, further comprising:
the conferencing system presenting to the private participant the audio conference and a private conference interface, the private conference interface displaying the participant objects identifying each of the public participants, and displaying further participant objects identifying the at least one private participants.

3. The method of claim 2, wherein the conferencing system presenting the audio conference comprises disabling an audio stream corresponding to the at least one private participant.

4. The method of claim 3, wherein the disabling the audio stream comprises muting the audio stream.

5. The method of claim 2, wherein the at least one private participant comprises two or more private participants, and further comprising:
the conferencing system enabling the two or more private participants to privately interact with each other via the private conference interface.

6. The method of claim 5, wherein the two or more private participants privately interact via one or more of a chat application, a messaging application, a collaboration application, or a document sharing application.

7. The method of claim 5, wherein the private interaction between the two or more private participants comprises one or more of sending a chat message, sending a social networking message, and sharing a document.

8. The method of claim 1, wherein the at least one private participant is designated by a host.

9. The method of claim 1, wherein the at least one private participant is designated by the corresponding participant.

10. The method of claim 1, further comprising:
the conferencing system receiving a request from the at least one private participant to join the audio conference as a new public participant.

11. The method of claim 10, further comprising:
the conferencing system electronically designating the at least one private participant as a new public participant; and
the conferencing system displaying in the public conference interface a further participant object to identify the new public participant.

12. A computer program embodied in a computer readable medium and executable by a processor for providing an online conference, the computer program comprising:
logic configured to establish an audio conference between a plurality of participants operating corresponding computing devices connected via a communication network;
logic configured to designate at least one of the participants as a private participant that participates in the audio conference in a private mode and a remaining portion of the participants that participant in the audio conference in a public mode; and
logic configured to present the audio conference to the public participants via a public conference interface that visually identifies only the public participants.

13. The computer program of claim 12, wherein the public conference interface displays on the corresponding computing devices a participant object identifying each of the public participants.

14. The computer program of claim 12, further comprising:
logic configured to present the audio conference to the private participants via a private conference interface that visually identifies the public participants and the private participants.

15. The computer program of claim 12, wherein the at least one private participant is designated by one of a host or the corresponding participant.

16. The computer program of claim 12, further comprising:
logic configured to enable the private participant to switch from the private mode to the public mode via the private conference interface.

17. The computer program of claim 12, further comprising:
logic configured to enable the private participants to privately interact with each other via the private conference interface without notifying the public participants via the public conference interface.

18. The computer program of claim 17, wherein the private conference interface enables the private participants to send messages or share documents with each other.

19. A computer system comprising:
a conferencing system for establishing an audio conference between a plurality of participants operating computing devices connected via a communication network; and
a server configured to communicate with the conferencing system and the plurality of computing devices via the communication network, the server comprising one or more processors and a private participant control module, which is stored in a computer readable medium and executed by the processors, the private participant control module comprising:
logic configured to designate at least one of the participants as a private participant that participates in the audio conference in a private mode and a remaining portion of the participants that participant in the audio conference in a public mode; and
logic configured to present the audio conference to the public participants via a public conference interface that visually identifies only the public participants; and
logic configured to present the audio conference to the private participants via a private conference interface that visually identifies the public participants and the private participants.

20. The computer system of claim 19, wherein the private participant control module further comprises:
logic configured to enable the private participants to privately interact with each via the private conference interface without notifying the public participants.
